(19) United States
(12) Patent Application Publication
(10) Pub. No.: US 2006/0116080 A1
(43) Pub. Date: Jun. 1, 2006

(54) System for transmitting and receiving channel allocation acknowledgement messages in a mobile communication system

(75) Inventor: Kwang-Seop Eom, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/289,299

(22) Filed: Nov. 30, 2005

(30) Foreign Application Priority Data
Nov. 30, 2004 (KR) 2004-99439

(51) Int. Cl. H04B 17/00

(52) U.S. Cl. 455/62; 455/67.11

(57) ABSTRACT

After receiving the channel allocation information from a base station, a mobile station transmits a first CQI value in a first CQI transmission period and a second CQI value in a second CQI transmission period following the first CQI transmission period. The transmission of the first and second CQI values is a notification of the receipt of the channel allocation information. The mobile station measures and transmits CQI during a third CQI transmission period following the first and second CQI transmission periods.

### PRIORITY

This application claims the benefit under 35 U.S.C. § 119(a) of an application filed in the Korean Intellectual Property Office on Nov. 30, 2004 and assigned Serial No. 2004-99439, the entire contents of which are hereby incorporated by reference.

### BACKGROUND OF THE INVENTION

1. Field of the Invention

The present invention relates generally to a system and method for transmitting/receiving channel allocation acknowledgements from mobile terminals.

2. Description of the Related Art

The IEEE 802.16e communication system is a communication system employing an Orthogonal Frequency Division Multiplexing (OFDM)/OFDMA scheme to support a broadband transmission network for physical channels of the wireless MAN system.

The OFDM scheme is a kind of Multi-Carrier Modulation (MCM) scheme that modulates a plurality of orthogonal subcarriers, i.e., a plurality of orthogonal subcarrier channels, before transmission. In addition, the OFDMA scheme, a multiple access scheme based on the OFDM scheme, allocates some of he entire subcarriers to a particular mobile station (or a subscriber station (SS)).

The IEEE 802.16 communication system must support high-speed data transmission. To this end, the IEEE 802.16 communication system can use an Adaptive Modulation and Coding (AMC) scheme. The AMC scheme refers to a data transmission scheme for determining different modulation schemes and different coding schemes depending on channel conditions between a cell, or a base station (BS), and a mobile station (MS), thereby improving the full efficiency of the cell. The AMC scheme has a plurality of modulation schemes and a plurality of coding schemes, and modulates and codes channel signals by combining the modulation schemes and the coding schemes.

Commonly, each of the combinations of the modulation schemes and the coding schemes is referred to as a Modulation and Coding Scheme (MCS), and MCS level 1 through MCS level N can be defined according to the number of MCSs. That is, the AMC scheme adaptively determines a level of the MCS according to channel conditions between a base station and a mobile station connected to the base station, thereby improving the entire efficiency of the base station system.

In order to apply the AMC scheme to the communication system, mobile stations must periodically feed back channel condition information, i.e., channel quality information (CQI), of a downlink to the base station.

According to the current IEEE 802.16 standard, the base station broadcasts an uplink MAP (UL-MAP) message in order to enable the mobile stations to transmit the CQI. By receiving the UL-MAP message, the mobile stations can detect a fast feedback channel region. Table 1 below shows a format of an OFDMA frame including the UL-MAP.

TABLE 1

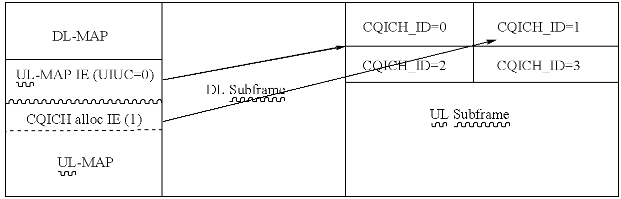

As shown in Table 1, an OFDMA frame includes a UL-MAP region, and the UL-MAP region includes a UL-MAP information element (IE) indicating each fast feedback channel region and a CQI channel allocation IE (CQICH alloc IE) indicating frequency band and time band/span information to be used when each mobile station feeds back CQI to the base station. In the OFDMA frame (Table. 1), a horizontal axis represents a time band and a vertical axis represents a frequency band.

In Table 1, UL-MAP IE (UIUC=0) means that the UL-MAP IE indicates a fast feedback channel region. That is, upon receiving the OFDMA frame, a mobile station becomes aware that it should feed back CQI to the base station, as a UIUC (Uplink Interval Usage Code) value of the UL-MAP IE in the UL-MAP region is ‘0’. In addition, the mobile station detects a frequency band and a time band mapped to information corresponding to its own basic connection identifier (CID) recorded in the CQICH alloc IE of the UL-MAP region, and feeds back CQI in the detected frequency band and time band. In Table 1, the mobile station can feed back CQI in a frequency band and a time band corresponding to, for example, CQICH_ID=1.

With reference to Table 2 and Table 3 below, a description will now be made of formats of the UL-MAP IE and the CQICH alloc IE.

Table 2 below shows a format of the UL-MAP IE for indicating the fast feedback channel region.

TABLE 2

| Syntax | Size | Notes |
|---|---|---|
| UL-MAP_IE( ) { | | |
| CID | 16 bits | Broadcast CID |
| UIUC | 4 bits | UIUC=0 indicates fast |
| | | feedback channel region |
| Duration | 10 bits | OFDMA slot unit |
| Repetition coding indication | 2 bits | 0b00 - No repetition |
| } | | |

Referring to Table 2, upon receiving a UL-MAP message in which UIUC=0 is recorded in the UL-MAP IE, the mobile station becomes aware that it should feed back CQI to the base station. The “Duration” field in the UL-MAP IE indicates a size of the fast feedback channel region OFDMA slot units. CID in Table 2 represents a broadcast CID, and is set such that all mobile stations located in the same cell have the same CID.

The UL-MAP region includes a plurality of UL-MAP IEs. For example, a first UL-MAP IE indicates an OFDMA slot having a length of Duration starting from a first subchannel and a first OFDMA symbol in a downlink frame period of an OFDMA frame. A second UL-MAP IE indicates an OFDMA slot having a length of Duration starting from a second subchannel and a second OFDMA symbol in the downlink frame period of the OFDMA frame. That is, if the UL-MAP IE in Table 2 is the first UL-MAP IE, the UL-MAP IE occupies a region of Duration=4 OFDMA slot starting from the first subchannel and the first OFDMA symbol.

Table 3 below shows a format of the CQICH alloc IE.

TABLE 3

| Syntax | Size | Notes |
|---|---|---|
| CQICH_alloc_IE( ) { | | |
| CID | 16 bits | Basic CID |
| UIUC | 4 bits | 15 |
| Extended DIUC | 4 bits | 0x03 |
| Length | 4 bits | Length of the message in bytes |
| CQICH_ID | variable | Index to uniquely identify the CQICH |
| | | resource assigned to the SS. |
| | | The size of this field is dependent on |
| | | system parameter defined in DCD. |
| Allocation offset | 6 bits | Index to the fast feedback channel region |
| | | marked by UIUC=0. |
| Period (p) | 2 bits | A CQI feedback is transmitted on the |
| | | CQICH every 2p frames. |
| Frame offset | 3 bits | The SS starts reporting at the frame of |
| | | which the number has the same 3 LSB as |
| | | the specified frame offset. If the current |
| | | frame is specified, the SS should start |
| | | reporting in 8 frames. |
| Duration (d) | 3 bits | A CQI feedback is transmitted on the CQI |
| | | channels indexed by the CQICH_ID for |
| | | 10 × 2^{d} frames. |
| | | If d=0, the CQICH is de-allocated. |
| | | If d=0b111, the SS should report until the |
| | | BS command for the SS to stop. |
| MIMO_permutation_Feedback_cycle | 2 bits | |
| Padding | variable | The padding bits are used to ensure the IE |
| | | size is integer number of bytes. |
| } | | |

Referring to Table 3, the mobile station reads a CQICH_alloc_IE corresponding to its own CID, and transmits CQI to the base station according to values of the parameters recorded therein. By reading the CQICH_alloc_IE, the mobile station detects a CQICH_ID and transmits the CQI in a frequency band and a time band corresponding to the CQICH_ID. Herein, the mobile station modulates a 4-bit payload indicated by the CQICH_ID before transmission. A value of the payload can be determined and recorded according to a signal-to-noise ratio (SNR) measured by the mobile station using Equation (1) below.
Payload bits=0 (if SNR<−2 dB) n(if2n−4<SNR<2n−2,0<n<15) 15(if SNR>26dB)Equation (1)

With reference to FIG. 1, a description will now be made of a CQI transmission/reception process between a base station and mobile stations in the conventional mobile communication system.

FIG. 1 is a signal flow diagram illustrating a CQI transmission/reception process between a base station and mobile stations in the conventional CDMA, TDMA, or OFDMA mobile communication system.

Referring to FIG. 1, a base station allocates a CQI channel to a first mobile station in step 102. The mobile station detects the CQI channel by receiving a UL-MAP and detecting a CQICH_alloc_IE therein in step 104. As a result, the mobile station periodically transmits CQI to the base station in predetermined frequency band and time band according to information recorded in fields of the CQICH_alloc_IE in step 106. Thereafter, the base station transmits a CQI channel deallocation command for the first mobile station in step 108, and allocates a CQI channel to another mobile station, i.e., a second mobile station, in step 110. Similarly, the second mobile station periodically transmits CQI to the base station in step 112. Herein, the base station transmits the CQI channel deallocation command for the first mobile station and immediately attempts CQI channel allocation to the second mobile station, without receiving an acknowledgement signal from the first mobile station in response to the CQI channel allocation/deallocation command.

The above-described conventional CQI transmission/reception process between the base station and the mobile stations may have the following problems.

When the base station allocates a CQI channel to the first mobile station, the first mobile station does not transmit an acknowledgement signal indicating receipt of the allocated CQI channel to the base station. The same thing (i.e., lack of an acknowledgement signal from the mobile station) happens even when the base station deallocates the CQI channel. In addition, the CQI transmitted by a mobile station does not include ID information used for identifying the mobile station. Therefore, after the CQI channel allocation/deallocation, the base station cannot determine which mobile station has transmitted the CQI.

### SUMMARY OF THE INVENTION

It is, therefore, an object of the present invention to provide a system and method for detecting CQI channel allocation, if any, in a mobile communication system.

It is another object of the present invention to provide a system and method for detecting CQI channel deallocation, if any.

According to one aspect of the present invention, after receiving the channel allocation information from a base station, a mobile station transmits a first CQI value in a first CQI transmission period and a second CQI value in a second CQI transmission period following the first CQI transmission period. The transmission of the first and second CQI values is a notification of the receipt of the channel allocation information. The mobile station measures and transmits CQI during a third CQI transmission period following the first and second CQI transmission periods.

### BRIEF DESCRIPTION OF THE DRAWINGS

The above and other objects, features and advantages of the present invention will become more apparent from the following detailed description when taken in conjunction with the accompanying drawings in which:

FIG. 1 is a signal flow diagram illustrating a CQI transmission/reception process between a base station and mobile stations in a conventional communication system;

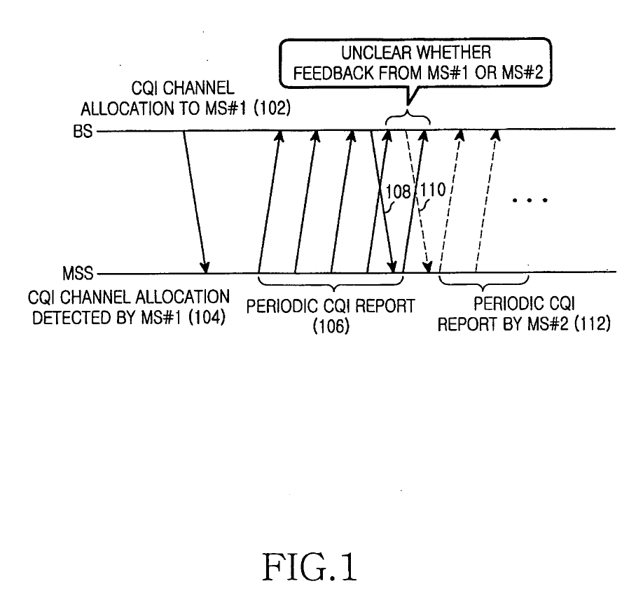

FIG. 2 is a signal flow diagram illustrating a CQI transmission/reception process between a base station and mobile stations in a mobile communication system according to an exemplary embodiment of the present invention;

FIG. 3 is a flowchart illustrating a CQI channel allocation attempt process performed by a base station in a mobile communication system according to an exemplary embodiment of the present invention;

FIG. 4 is a flowchart illustrating a CQI channel deallocation process performed by a base station in a mobile communication system according to an exemplary embodiment of the present invention;

FIG. 5 is a flowchart illustrating a CQI channel allocation process performed by a mobile station in a mobile communication system according to an exemplary embodiment of the present invention; and

FIG. 6 is a flowchart illustrating a CQI channel deallocation process performed by a mobile station in a mobile communication system according to an exemplary embodiment of the present invention.

### DETAILED DESCRIPTION OF EXEMPLARY EMBODIMENT

Exemplary embodiments of the present invention will now be described in detail with reference to the annexed drawings. In the following description, a detailed description of known functions and configurations incorporated herein has been omitted for clarity and conciseness.

According to an exemplary embodiment of the present invention, a mobile communication system may use an Orthogonal Frequency Division Multiple Access (OFDMA) scheme in which when a base station allocates or deallocates a channel quality information (CQI) channel for a mobile station, the mobile station transmits an acknowledgement in response thereto. The present invention may also be applicable to other access schemes including but not limited to such as CDMA and TDMA.

Some payload bit values of the CQI transmitted by the mobile station can be used for a particular purpose according to an embodiment of the present invention. For example, payload bit values of 0 and 15 among the possible payload bit values can be used as the particular purpose bit values, and the base station can recognize a signal combined of these bit values as an acknowledgement from a mobile station in response to the CQI channel allocation/deallocation.

The payload bits of the CQI can have information determined according to a signal-to-noise ratio (SNR) via a channel as measured by the mobile station using Equation (2) below.
Payload bits=0 (if SNR≦−2 dB or as particular purpose bit values)n(if 2n−4 <SNR≦2n−2, 0<n<15)15(if SNR>26 dB or as particular purpose bit values)

Referring to Equation (2), the mobile station can record 0, n, and 15 in CQI, and transmits the CQI to the base station in the current CQI transmission period. That is, if the mobile station records ‘0’ in the CQI before transmission, the base station can perceive that the SNR is lower than or equal to −2 dB. In addition, if the mobile station records ‘5’ in the CQI before transmission, the base station perceives a channel condition in which the SNR is higher than 6 dB and lower than 10 dB.

The present invention is provided on the assumption that the channel condition between the base station and the mobile station is not subject to abrupt change. CQI=0 transmitted by the mobile station indicates that the channel condition is bad and corresponds to the worst channel condition expressible via the CQI values, and CQI=15 indicates that the channel condition is good and corresponds to the best channel condition expressible via the CQI values. Therefore, it is assumed that the mobile station has practically no probability of transmitting a measured CQI value of ‘0’ in a previous CQI transmission period and transmitting a measured CQI value of ‘15’ in the current CQI transmission period. Similarly, the mobile station has practically no chance to transmit a measured CQI value of ‘15’ in the previous CQI transmission period and transmit a measured CQI value of ‘0’ in the current CQI transmission period.

Generally, the channel condition between the base station and the mobile station is subject to step-by-step change, but is not subject to the above-stated abrupt change. Based on this fact, if the mobile station transmits CQI equal to ‘0’ in the previous CQI transmission period and CQI equal to ‘15’ in the current CQI transmission period, it means herein that the mobile station will start CQI transmission after successfully receiving an allocated CQI channel. In addition, if the mobile station transmits CQI equal to ‘15’ in the previous CQI transmission period and CQI equal to ‘0’ in the current CQI transmission period, it means that the mobile station will stop CQI transmission after detecting CQI channel deallocation.

Table 4 below shows possible CQI combinations according to an embodiment of the present invention.

TABLE 4

| Tx order | Description |
|---|---|
| (0, 15) | It means that a mobile station will transmit CQI after |
| | being allocated a CQI channel. |
| (15, 0) | It means that a mobile station will stop CQI transmission |
| | after being deallocated a CQI channel. |

Different CQI combinations can be used according to exemplary embodiments of the present invention., if the mobile station transmits CQI=‘15’ in the previous CQI transmission period and CQI=‘0’ in the current CQI transmission period, the arrangement between the base station and the mobile terminal can be such that the base station will receive a notice that mobile station will start CQI transmission after receiving an allocated CQI channel. In addition, if the mobile station transmits CQI=‘0’ in the previous CQI transmission period and CQI=‘15’ in the current CQI transmission period, it can serve as a notice to the base station that the mobile station will stop CQI transmission after detecting CQI channel deallocation.

Further, the CQI values transmitted by a mobile station to acknowledge its receipt of the allocation command and/or the deallocation command from the base station can include an ID information identifying the mobile station so that the base station can identify which mobile station transmitted the acknowledgement message. A description of exemplary embodiments of the present invention will be made with reference to the CQI combinations of Table 4.

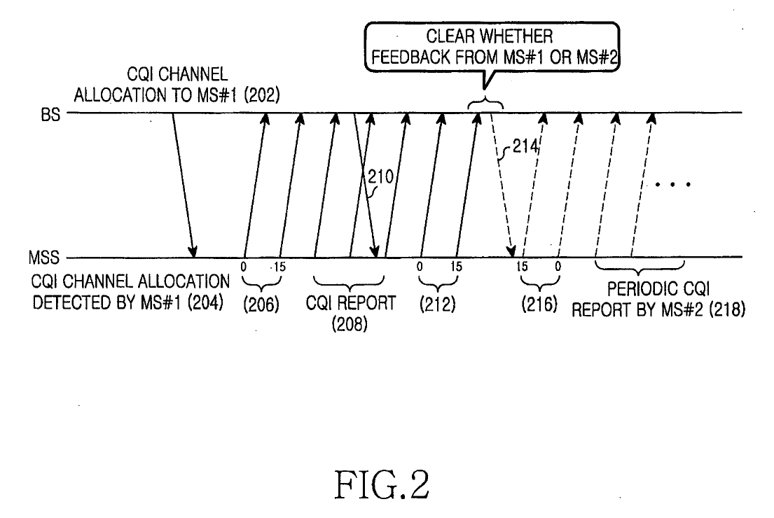

FIG. 2 is a signal flow diagram illustrating a CQI transmission/reception process between a base station and mobile stations in an OFDMA mobile communication system according to an exemplary embodiment of the present invention.

Referring to FIG. 2, a base station allocates a CQI channel to a first mobile station in step 202. The mobile station receives a UL-MAP message and detects a CQICH_alloc_IE therein in step 204. Thereafter, according to the embodiment of the present invention, the first mobile station transmits CQI=‘0’ and CQI=‘15’ over two CQI transmission periods so that the base station can detect that the CQI channel has been successfully allocated, in step 206. Next, the first mobile station periodically transmits CQI to the base station in predetermined frequency band and time span according to information recorded in fields of the CQICH_alloc_IE in step 208. Thereafter, the base station transmits a CQI channel deallocation command for the first mobile station in step 210. Upon receiving the CQI channel deallocation command, the first mobile station transmits CQI=‘15’ in the current CQI transmission period and CQI=‘0’ in the next CQI transmission period according to an exemplary embodiment of the present invention, in step 212.

For instance, if the first mobile station transmits CQI=‘15’ at a particular CQI transmission time t and CQI=‘0’ at a CQI transmission time (t+1) as described above, the base station is informed that the first mobile station has successfully received a CQI channel deallocation command from the base station and will stop the transmission of CQI, starting at the transmission time (t+3), until it receives another channel allocation command. Therefore, the base station can allocate a CQI channel to another mobile station, i.e., a second mobile station, in step 214. Upon receiving an allocated CQI channel from the base station, the second mobile station transmits CQI=‘0’ at a CQI transmission time (t+2) and CQI=‘15’ at a CQI transmission time (t+3) in step 216, and periodically transmits actual CQI, starting at a CQI transmission time (t+4) in step 218, and can maintain such status if needed until it receives a channel deallocation command. Upon receiving CQI=‘0’ and CQI=‘15’ over two CQI transmission periods, the base station becomes aware that the second mobile station has been successfully allocated the CQI channel. The CQI transmission times t, (t+1), t+2), and (t+3) can be immediately adjacent CQI transmission time periods.

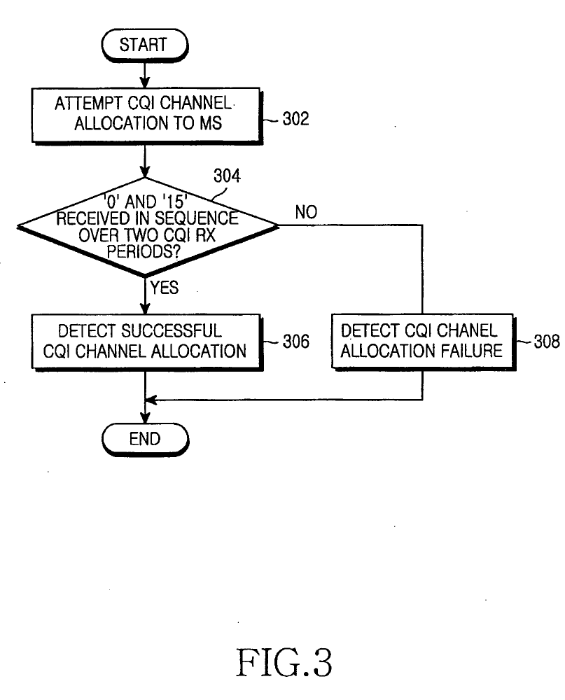

FIG. 3 is a flowchart illustrating a CQI channel allocation attempt process performed by a base station in an OFDMA mobile communication system according to an embodiment of the present invention.

Referring to FIG. 3, a base station attempts CQI channel allocation for a particular mobile station in step 302. If the base station receives CQI=‘0’ at a particular CQI reception (RX) time and CQI=‘15’ at the next CQI reception time in step 304, the base station proceeds to step 306. In step 306, the base station detects that the CQI channel allocation for the particular mobile station has been successfully achieved. However, if the base station fails to sequentially receive ‘0’ and ‘15’ over the two CQI reception periods in step 304, the base station proceeds to step 308. In step 308, the base station detects that the CQI channel allocation attempt for the particular mobile station has failed. At the same time, if another CQI value is received, the base station recognizes the received CQI as a general channel condition reporting CQI transmitted by another mobile station that was previously allocated a CQI channel.

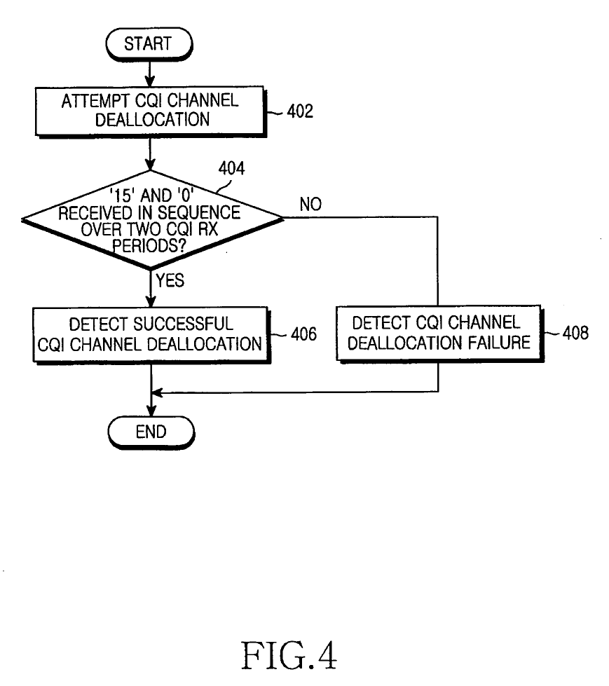

FIG. 4 is a flowchart illustrating a CQI channel deallocation process performed by a base station in an OFDMA mobile communication system according to an embodiment of the present invention.

Referring to FIG. 4, a base station attempts CQI channel deallocation for a mobile station that is currently transmitting CQI, in step 402. If the base station receives CQI=‘15’ at a particular CQI reception time and CQI=‘0’ at the next CQI reception time in step 404, the base station proceeds to step 406. In step 406, the base station becomes aware that the CQI channel deallocation for the mobile station has been successfully performed. However, if the base station fails to sequentially receive CQI=‘15’ and CQI=‘0’ over the two CQI reception periods in step 404, the base station proceeds to step 408. In step 408, the base station detects that the CQI channel deallocation attempt for the particular mobile station has failed. At the same time, if another CQI value is received, the base station recognizes the received CQI as a general channel condition reporting CQI transmitted by the mobile station.

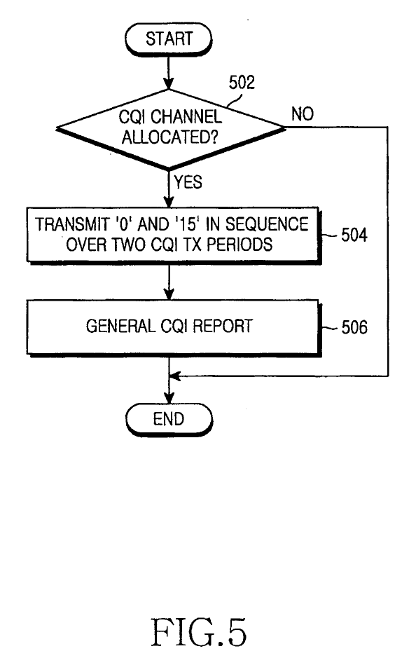

FIG. 5 is a flowchart illustrating a CQI channel allocation process performed by a mobile station. The mobile station may be an element in an OFDMA mobile communication system according to an exemplary embodiment of the present invention. However, the mobile station may also be an element in other communication systems including CDMA and TDMA.

Referring to FIG. 5, a mobile station determines in step 502 whether it has been allocated a CQI channel from a base station. If it is determined that the mobile station has been allocated a CQI channel, the mobile station proceeds to step 504. In step 504, the mobile station sequentially transmits CQI=‘0’ and CQI=‘15’ to the base station over two CQI transmission periods, indicating that it has been successfully allocated the CQI channel. In step 506, the mobile station periodically measures and transmits a general CQI to the base station. In response to the transmitted general CQI, the base station detects that the mobile station is reporting the CQI after the CQI channel allocation for the mobile station has been successfully achieved. However, if it is determined in step 502 that the mobile station has failed to be allocated a CQI channel from the base station, the mobile station ends the process without performing a separate operation.

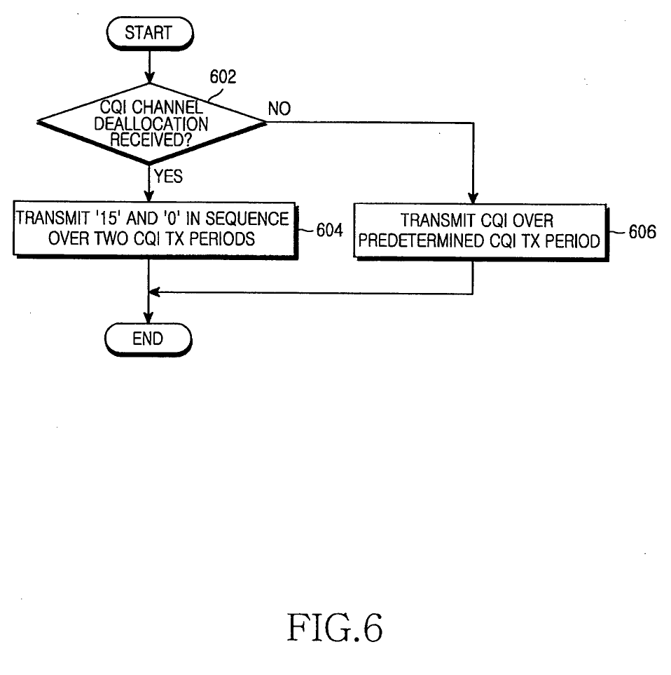

FIG. 6 is a flowchart illustrating a CQI channel deallocation process performed by a mobile station according to an exemplary embodiment of the present invention.

Referring to FIG. 6, a mobile station determines in step 602 whether it has received a CQI channel deallocation command from a base station. If it is determined that the mobile station has received the CQI channel deallocation command, the mobile station proceeds to step 604, and otherwise, proceeds to step 606. In step 604, the mobile station sequentially transmits CQI=‘15’ and CQI=‘0’ to the base station over two CQI transmission periods (which can be immediately adjacent to one another but may also be spread apart), indicating that it will deallocate the CQI channel previously allocated thereto, i.e., indicating that it will stop CQI transmission. After receiving the CQIs, the base station can detect that the CQI channel allocated to the mobile station is deallocated and may allocate a CQI channel to another base station. In step 606, the mobile station performs CQI transmission for a period specified in a duration field of a CQICH_alloc_IE unless a CQI channel deallocation message is received from the base station.

As can be understood from the foregoing description, after performing CQI channel allocation and deallocation for a mobile station, the base station can receive an acknowledgement from the mobile station in response thereto, which acknowledgement can contribute to efficient management of the system resources among other things.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting channel quality information (CQI) with a mobile station in a wireless communication system, the method comprising the steps of:
receiving information of a channel allocation by a base station;
after receiving the channel allocation information, transmitting a first CQI value in a first CQI transmission period and a second CQI value in a second CQI transmission period following the first CQI transmission period, wherein the transmission of the first and second CQI values is a notification of the receipt of the channel allocation information; and
measuring and transmitting CQI during a third CQI transmission period following the first and second CQI transmission periods.

2. The method of claim 1, wherein the first CQI value indicates one of the best channel condition expressible via a CQI value and the worst channel condition expressible via a CQI value and the second CQI value indicates the other one of the best and worst channel conditions.

3. The method of claim 2, wherein the first CQI value indicates the best channel condition.

4. The method of claim 1, wherein the first and second CQI transmission periods are immediately adjacent to each other in time.

5. The method of claim 1, wherein the receiving from a base station information of an allocation of a channel comprises receiving an uplink MAP UL-MAP) message that is broadcasted.

6. The method of claim 1, wherein the CQI is determined according to a signal-to-noise ratio.

7. The method of claim 1, further comprising the step of, upon receiving a channel deallocation command from the base station, transmitting the second CQI value in a fourth CQI transmission period and transmitting the first CQI value in a fifth CQI transmission period following the fourth CQI transmission period, wherein the transmission of the second and first CQI values after receiving the deallocation command is a notification of the receipt of the deallocation command.

8. The method of claim 1, wherein the transmitting of the first CQI value in the first CQI transmission period and the second CQI value in the second CQI transmission period comprises transmitting identification information of the mobile station.

9. A method for receiving channel quality information (CQI) by a base station in a wireless communication system including a mobile station and the base station for receiving CQI from the mobile station, the method comprising the steps of:
allocating a channel for CQI transmission to the mobile station;
after transmitting a notification of the channel allocation, detecting a successful channel allocation when a first CQI value is received in a first CQI reception period and a second CQI value is received in a second CQI reception period following the first CQI reception period; and
receiving CQI during a period beginning with a third CQI reception period following the second CQI reception period.

10. The method of claim 9, wherein the first CQI value indicates one of the best channel condition expressible via a CQI value and the worst channel condition expressible via a CQI value and the second CQI value indicates the other one of the best and worst channel conditions.

11. The method of claim 10, wherein the first CQI value indicates the best channel condition.

12. The method of claim 9, wherein the first and second CQI reception periods are immediately adjacent to each other in time.

13. The method of claim 9, wherein the base station allocates the channel for CQI transmission based on an uplink MAP (UL-MAP) message that is broadcasted.

14. The method of claim 9, wherein the CQI is determined according to a signal-to-noise ratio.

15. The method of claim 9, further comprising the step of, upon receiving the second CQI value in a fourth CQI transmission period and transmitting the first CQI value in a fifth CQI transmission period following the fourth CQI transmission period, detecting a receipt notification by the mobile station of a deallocation command.

16. The method of claim 9, wherein the detecting a successful channel allocation comprises receiving identification information of the mobile station.

17. A system for communicating channel quality information (CQI), he system comprising:
a base station; and
a mobile station adapted to (i) detect an allocation of a channel by a base station, (ii) transmit a first CQI value in a first CQI transmission period and a second CQI value in a second CQI transmission period following the first CQI transmission period, and (iii) measure and transmit CQI during a third CQI transmission period following the first and second CQI transmission periods, wherein the base station detects the combination of the first and second CQI values as a notification of the mobile station's receipt of the channel allocation information.

18. The system of claim 17, wherein the first CQI value indicates one of the best channel condition expressible via a CQI value and the worst channel condition expressible via a CQI value and the second CQI value indicates the other one of the best and worst channel conditions.

19. The system of claim 18, wherein the first CQI value indicates the best positive channel condition.

20. The method of claim 17, wherein the first and second CQI transmission periods are immediately adjacent to each other in time.

21. The system of claim 17, wherein the base station is adapted to, upon receiving the second CQI value in a fourth CQI transmission period and transmitting the first CQI value in a fifth CQI transmission period following the fourth CQI transmission period, detect a receipt by the mobile station of a deallocation command.

22. The system of claim 17, wherein the base station is adapted to detect a successful channel allocation when the first CQI value is received in the first CQI reception period and the second CQI value is received in a second CQI reception period following the first CQI reception period.

23. The system of claim 17, wherein the mobile station is adapted to transmit identification information of the mobile station when the mobile station transmits the first and second CQI values.
